(19) United States
(12) Patent Application Publication
(10) Pub. No.: US 2026/0285683 A1
(43) Pub. Date: Sep. 24, 2026

(54) METHOD FOR PREPARING BORON NITRIDE NANOSHEETS, METHOD FOR PREPARING BORON NITRIDE NANOSHEET-BASED FIBERS, AND FIBERS PREPARED THEREBY

(71) Applicant: IUCF-HYU (INDUSTRY-UNIVERSITY COOPERATION FOUNDATION HANYANG UNIVERSITY), Seoul (KR)

(72) Inventors: Tae Hee Han, Seoul (KR); Dong Jun Kang, Seoul (KR); Hwa Young Ko, Seoul (KR); Jun Ho Lee, Seoul (KR); Soo In Hwang, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 19/560,581

(22) Filed: Mar. 9, 2026

(30) Foreign Application Priority Data
Mar. 20, 2025 (KR) 10-2025-0036115

(51) Int. Cl. C01B 21/064; D01D 5/06; D01F 9/08

(52) U.S. Cl. CPC C01B 21/0648; D01D 5/06; D01F 9/08; C01P 2002/72; C01P 2002/82; C01P 2002/85; C01P 2002/88; C01P 2004/02; C01P 2004/03; C01P 2006/12; D10B 2101/14

(57) ABSTRACT

A method for manufacturing boron nitride nanosheets, a method for manufacturing boron nitride nanosheet-based fibers, and fibers manufactured thereby are provided. In the method for manufacturing boron nitride nanosheet-based fibers, a radical initiator is added to boron nitride nanosheets (BNNS) for a solvothermal reaction under basic conditions to form hydroxyl-functionalized BNNS (o-BNNS). The o-BNNS is then dispersed and centrifuged to prepare a liquid crystalline boron nitride dope solution, which is subsequently wet-spun and dried. This process enables the facile production of fibers characterized by high mechanical strength, improved thermal conductivity, and superior electrical insulation.

### CLAIM FOR PRIORITY

This application claims priority to Korean Patent Application No. 10-2025-0036115 filed on Mar. 20, 2025 with the Ministry of Intellectual Property (MOIP), the entire contents of which are hereby incorporated by reference.

### BACKGROUND

### 1. Technical Field

Example embodiments of the present invention relate to a fiber material, and more particularly, to a method for preparing boron nitride nanosheets, a method for preparing boron nitride nanosheet-based fibers, and fibers prepared thereby.

### 2. Related Art

Since the mechanical and physicochemical properties of nanomaterials vary depending on the ratio of surface atoms to internal atoms, extensive research is being conducted to implement desired characteristics by utilizing such a ratio. In addition, development is underway for nanomaterial assembly technologies that assemble various nanomaterials into forms such as films, coatings, or monoliths. Specifically, in the fiber field, technologies have been proposed to realize one-dimensional fiber assemblies using various nanomaterials, such as graphene oxide, carbon nanotubes, or MXenes.

However, carbon-based fiber assemblies require a high-temperature reduction process of 2,000° C. or higher to prevent degradation of thermal and electrical conductivity. Since the maxine fiber assembly is inherently conductive, i.e., exhibits high electrical conductivity, its application as an electrical insulating material is limited to electrically conductive materials, and its thermal conductivity also remains at 2 to 10 W·m⁻¹·K⁻¹, which limits its heat dissipation performance.

### SUMMARY

Accordingly, example embodiments of the present invention provide a method for preparing boron nitride nanosheets, a method for preparing boron nitride nanosheet-based fibers, and fibers prepared thereby, which can improve thermal conductivity and structural stability.

The technical objects of the present invention are not limited to the technical objects mentioned above, and other technical objects not mentioned will be clearly understood by those skilled in the art from the following description.

In some example embodiments, a method for manufacturing a boron nitride nanosheet-based fiber is provided. The method comprises preparing boron nitride nanosheets (BNNS); forming hydroxyl-functionalized boron nitride nanosheets (o-BNNS) by adding a radical initiator and a base to the BNNS and performing a solvothermal reaction; dispersing the o-BNNS in a dispersion solvent and centrifuging the same to form a liquid crystalline boron nitride dope solution; forming gel fibers by wet-spinning the liquid crystalline boron nitride dope solution; and drying the gel fibers.

The BNNS may have have vacancies formed therein.

The radical initiator may comprise a peroxide.

The base may comprise at least one selected from the group consisting of sodium hydroxide (NaOH), lithium hydroxide (LiOH), and potassium hydroxide (KOH). The base may comprise the NaOH and the KOH in a weight ratio of 1:1 to 1:1.5.

The solvothermal reaction may be performed at a first reaction temperature of 120 to 160° C., at which the radical initiator is thermally initiated; and at a second reaction temperature of 180 to 250° C., at which the base becomes a molten salt.

An atomic ratio of oxygen contained in o-BNNS may be 5 to 25%.

The method may further comprise washing the o-BNNS with a polar solvent prior to forming the liquid crystalline boron nitride dope solution.

A concentration of the o-BNNS in the liquid crystalline boron nitride dope solution may be 1 to 4 wt %.

The method may further comprise adding a dispersant to the liquid crystalline boron nitride dope solution prior to wet-spinning the liquid crystalline boron nitride dope solution. A weight ratio of the o-BNNS to the dispersant in the liquid crystalline boron nitride dope solution may be 2:0.4 to 2:4.

In some example embodiments, a method for manufacturing boron nitride nanosheets is provided. The method comprises heat-treating hexagonal boron nitride (h-BN) powder in a water vapor atmosphere; and forming boron nitride nanosheets (BNNS) by dispersing the heat-treated h-BN powder in a solvent and then performing ultrasonic treatment.

The heat-treating may be performed at a temperature higher than 800° C. and not higher than 1,200° C.

An average size of the BNNS may be 10 to 40 μm².

In some example embodiments, a fiber is provided. The fiber comprises boron nitride nanosheets, wherein hydrogen bonds are formed between the boron nitride nanosheets.

Vacancies may be formed inside the boron nitride nanosheets. The boron nitride nanosheets may be aligned in an axial direction of the fiber.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a method for preparing boron nitride nanosheets according to an embodiment of the present invention;

FIG. 2 is a schematic diagram showing h-BN crystals before exfoliation, BNNS formed by heat-treating and then exfoliating the h-BN, and the changes in BNNS according to the heat treatment temperature, according to an embodiment of the present invention;

FIG. 3 is a flowchart illustrating a method for manufacturing boron nitride nanosheets-based fibers according to an embodiment of the present invention;

FIG. 4 is a schematic view showing a portion of a boron nitride nanosheet-based fiber manufactured according to an embodiment of the present invention;

FIG. 5a is a schematic diagram illustrating wet-spinning process of the liquid crystalline boron nitride dope solution according to Boron Nitride Fiber (BNF) Preparation Example 1, and FIG. 5b is an actual image of the wet-spinning process;

FIG. 6a is a scanning electron microscope (SEM) image of h-BN crystals after the heat treatment process in BNNS Preparation Example 2, and FIG. 6b is an SEM image of the BNNS formed by exfoliation after the heat treatment in BNNS Preparation Example 2;

FIGS. 7b and 7c are SEM images of the BNNS obtained in BNNS Comparative Example 1, FIG. 7a is a photograph of a BNNS dispersion containing the BNNS obtained from BNNS Comparative Example 1 exhibiting the Tyndall effect to evaluate the degree of dispersion, and FIG. 7d is a graph of the particle size distribution showing the degree of dispersion of the BNNS obtained from BNNS Comparative Example 1;

FIGS. 8b and 8c are SEM images of the BNNS obtained in BNNS Preparation Example 2, FIG. 8a is a photograph of a BNNS dispersion containing the BNNS obtained from BNNS Preparation Example 1 exhibiting the Tyndall effect to evaluate the degree of dispersion, and FIG. 8d is a graph of the particle size distribution showing the degree of dispersion of the BNNS obtained from BNNS Preparation Example 1;

FIGS. 9 to 11, respectively, show results analyzed by Fourier transform infrared (FTIR) spectroscopy, X-ray diffraction (XRD), and X-ray photoelectron spectroscopy (XPS) of the o-BNNS powders obtained through the solvothermal reaction in BNF Preparation Examples 1 to 3 and Comparative Example 1;

FIG. 12 is a graph comparing the atomic ratios calculated using XPS for the o-BNNS powders obtained through the solvothermal reaction in BNF Preparation Examples 1 to 3 and Comparative Example 1;

FIG. 13 is a graph comparing the zeta potential, which represents the surface potential, of o-BNNS obtained after the solvothermal reaction in BNF Preparation Example 2 and Comparative Example 1;

FIGS. 14a, 14b, 14c, and 14d are images showing the gel fibers formed in a coagulation bath through wet-spinning using a spinneret in BNF Preparation Examples 4, 5, 2 and 6, respectively;

FIG. 15a shows photographic images and FIGS. 15b and 15c are cross-sectional SEM images of the boron nitride nanosheet-based fiber obtained in BNF Preparation Example 2;

FIGS. 16a, 16b, and 16c are polarized optical microscopy (POM) images observing the liquid crystalline phase with a 200 m gap for the liquid crystalline boron nitride dope solution containing 2 wt % o-BNNS prepared in BNF Preparation Example 2, the liquid crystalline boron nitride dope solution containing 2 wt % o-BNNS and 2 wt % CNC prepared in BNF Preparation Example 8, and the liquid crystalline boron nitride dope solution containing 2 wt o-BNNS prepared in BNF Comparative Example 1, respectively;

FIGS. 17a and 17b are Fourier-transform infrared (FTIR) spectra of the BNFs from BNF Preparation Example 7 and Comparative Example 2, and the CNC dispersant as a control;

FIG. 18 is a graph comparing the thermal conductivity of the fibers prepared from BNF Preparation Examples 2, 7 to 9 and Comparative Examples 2 and 3; and

FIG. 19 is a graph comparing the tensile stress of the fibers prepared in BNF Preparation Examples 2, 7 to 9 and Comparative Examples 2 and 3.

### DESCRIPTION OF EXAMPLE EMBODIMENTS

Hereinafter, embodiments according to the present invention will be described in detail with reference to the accompanying drawings.

While the present invention is susceptible to various modifications and alternative forms, specific embodiments thereof are shown by way of example in the drawings and will be described in detail herein. However, it is not intended to limit the invention to the particular forms disclosed, but on the contrary, the invention is to cover all modifications, equivalents, and alternatives falling within the spirit and scope of the invention as defined by the claims.

It will be understood that when an element such as a layer, region, or substrate is referred to as being “on” another element, it can be directly on the other element or intervening elements may also be present.

It will be understood that, although the terms first, second, etc. may be used herein to describe various elements, components, regions, layers, and/or sections, these elements, components, regions, layers, and/or sections should not be limited by these terms.

### Method for Preparing Boron Nitride Nanosheets

One aspect of the present invention may provide a method for preparing boron nitride nanosheets (BNNS). The BNNS may refer to sheets composed of boron nitride having a thickness on a nanometer (nm) scale and a lateral size on a micrometer (μm) scale. Specifically, the thickness of the BNNS may be 2 nm or less. The BNNS may have a single atomic layer or multiple atomic layers of fewer than 10 atomic layers.

FIG. 1 is a flowchart illustrating a method for preparing BNNS according to an embodiment of the present invention.

Referring to FIG. 1, the method for preparing BNNS may include heat-treating hexagonal boron nitride (h-BN) powder in a water vapor atmosphere (S110). The h-BN powder may be a white powder with scale-like particles and each particle possesses a layered structure in which two-dimensional unit layers, formed by a hexagonal lattice of boron (B) and nitrogen (N) atoms through sp² hybridization, are stacked together.

The water vapor atmosphere may refer to a reaction environment composed of air containing water molecules (H₂O), that is, humid air. By heat-treating the h-BN in the water vapor atmosphere, vacancies may be formed inside the h-BN. Specifically, when the h-BN is heat-treated in the water vapor atmosphere, the chemical bonds between the boron and nitrogen atoms constituting the h-BN may be broken, allowing them to react with the water vapor. As the h-BN reacts with the water vapor, certain regions of the h-BN may undergo hydration. Accordingly, the boron atoms constituting the h-BN may be precipitated as BO₃ crystals, and the nitrogen atoms constituting the h-BN may be generated as NO₂ gas. Consequently, vacancies may be formed within the h-BN. That is, the vacancies may refer to regions where the bonds between the boron atoms and the nitrogen atoms have been broken.

The heat treatment of the h-BN powder may be performed at a temperature exceeding 800° C. and up to 1,200° C. Specifically, the heat treatment may be conducted in a range from 850° C., the temperature at which h-BN begins to thermally degrade, to 1,200° C., the temperature at which re-thermal reduction of h-BN occurs. The temperature range for performing the heat treatment may be 850 to 1,200° C., specifically 900 to 1,100° C., more specifically 950 to 1,050° C., and for example at 1,000° C. By heat-treating the h-BN within the aforementioned temperature range, the formation of vacancies inside the h-BN can be optimized. Furthermore, by heat-treating the h-BN in the water vapor atmosphere, oxygen functional groups may be partially introduced into certain regions of the h-BN.

The heat treatment time for the h-BN powder may be 30 to 210 minutes, specifically 60 to 180 minutes, more specifically 90 to 150 minutes, and for example for 2 hours.

Next, the heat-treated h-BN powder may be dispersed in a solvent and then ultrasonicated to form boron nitride nanosheets (BNNS) (S120). That is, a plurality of BNNS can be exfoliated from the heat-treated h-BN powder.

The solvent may be an exfoliation solvent for exfoliating the BNNS from the heat-treated h-BN powder. The heat-treated h-BN powder may be added to and dispersed in the solvent at a concentration of 1 to 10 mg/mL, specifically 2 to 6 mg/mL, more specifically 2 to 4 mg/mL, and for example 3 mg/mL.

The solvent may be a solvent that does not react with the heat-treated h-BN powder. Specifically, the solvent may have a surface tension of 40 mJ/m² or less. Using a solvent with a surface tension within the aforementioned range may ensure appropriate wettability, facilitating the penetration of the solvent into the heat-treated h-BN powder and improving exfoliation efficiency.

More specifically, the solvent may include at least one selected from polar protic solvents with low proton-donating ability, such as isopropyl alcohol (IPA); aprotic solvents, such as N-methyl-2-pyrrolidinone (NMP); and water. In one embodiment, the solvent may be a mixture of IPA and deionized water (DI water).

Ultrasonication of the h-BN dispersion, in which the heat-treated h-BN powder is dispersed in the solvent, may be performed for 30 to 90 minutes, specifically 45 to 75 minutes, more specifically 55 to 65 minutes, and for example for 60 minutes.

As described above, in the method for manufacturing BNNS of the present invention, the h-BN may be heat-treated within an optimal temperature range before exfoliation, and then the heat-treated h-BN may be exfoliated to produce the BNNS. Accordingly, vacancies can be formed within the produced BNNS. In one embodiment, one or more vacancies may be formed within a basal plane of the BNNS, where nitrogen and boron are connected via sp² hybridized bonds. The boundaries of these vacancies may act as internal edges with exposed dangling bonds formed by the disconnection of chemical bonds between nitrogen and boron, through which oxygen-containing functional groups, specifically hydroxyl groups (—OH), can be introduced. The manufacturing method of the present invention can effectively increase the edge area where the oxygen-containing functional groups can be introduced into the BNNS.

Furthermore, in the method for manufacturing BNNS of the present invention, the exfoliation process may be performed after forming the vacancies in the h-BN. Consequently, the produced BNNS can maintain an appropriate size suitable for assembly into fibers.

Specifically, for example, the average size of the BNNS produced by the manufacturing method may be 10 to 40 μm². Additionally, the average size of the vacancies (pore size) within the BNNS may be 0.001 to 0.009 μm², specifically 0.003 to 0.007 μm², more specifically 0.004 to 0.006 μm², and for example 0.005 to 0.0058 μm². Reference may be made to the following Examples.

In addition, as the vacancies are formed within the h-BN, the interlayer bonding force of the h-BN may become weaker compared to a case where no vacancies are formed, thereby increasing the exfoliation efficiency.

Moreover, due to the heat treatment of the h-BN in the water vapor atmosphere, a small amount of hydroxyl groups (—OH) may be introduced at the edges of the h-BN. The hydroxyl groups introduced at the edges can increase affinity with the solvent added for exfoliation, further improving the exfoliation efficiency.

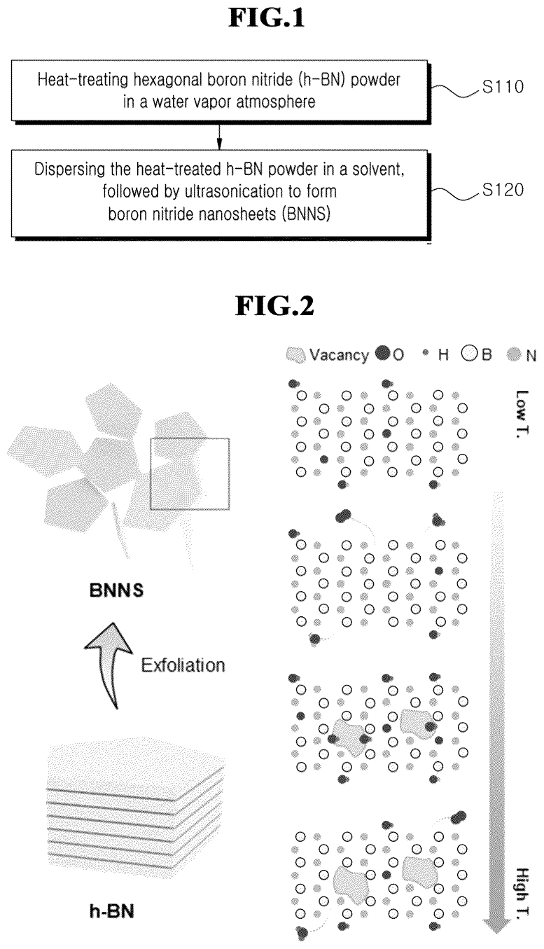

FIG. 2 is a schematic diagram showing h-BN crystals before exfoliation, BNNS formed by heat-treating and then exfoliating the h-BN, and the changes in BNNS according to the heat treatment temperature, according to an embodiment of the present invention.

Referring to FIG. 2, in the case of BNNS obtained by exfoliating h-BN without heat treatment and BNNS obtained by heat-treating h-BN at a temperature lower than the optimized range followed by exfoliation, the edge areas where oxygen-containing functional groups can be introduced may be limited primarily to the periphery of the BNNS due to their inherent flat structural characteristics.

However, in the case of BNNS formed by heat-treating the h-BN in a water vapor atmosphere within the optimized temperature range and then exfoliating it, the edge area can be increased due to the vacancies formed inside the BNNS. Consequently, numerous oxygen-containing functional groups can be introduced not only at the periphery but also inside the BNNS.

Nevertheless, in the case of BNNS formed by heat-treating the h-BN in a water vapor atmosphere at an excessively high temperature and then exfoliating it, the oxygen-containing functional groups temporarily introduced into a portion of the BNNS may undergo desorption.

### Manufacturing Method of Boron Nitride Nanosheet-Based Fiber

Another aspect of the present invention provides a method for manufacturing boron nitride nanosheet-based fibers.

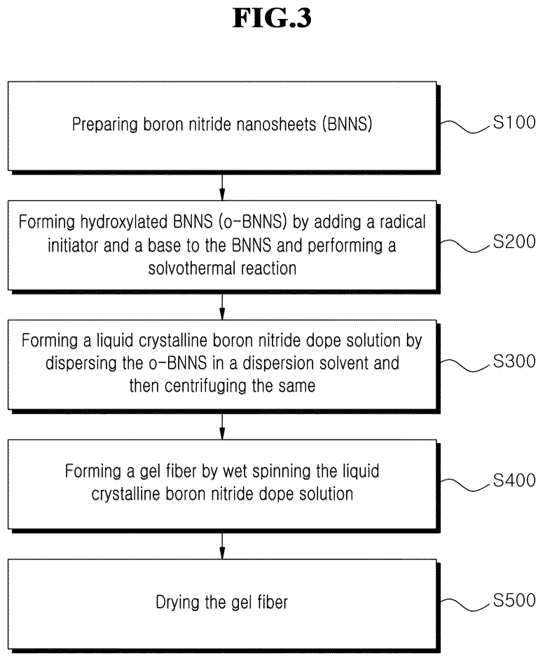

FIG. 3 is a flowchart illustrating a method for manufacturing boron nitride nanosheets-based fibers according to an embodiment of the present invention.

Referring to FIG. 3, the method may include preparing boron nitride nanosheets (BNNS) (S100). In one embodiment, the BNNS may be those prepared by the manufacturing method of BNNS described above. Specifically, the BNNS may be formed by heat-treating and then exfoliating hexagonal boron nitride (h-BN). Additionally, the BNNS may have vacancies formed therein. For a detailed description of the BNNS, reference may be made to the aforementioned description of the BNNS manufacturing method to avoid redundancy.

Next, BNNS having hydroxyl groups, which are hydroxylated BNNS (o-BNNS), may be formed by adding a radical initiator and a base to the BNNS and subjecting the resultant to a solvothermal reaction (S200). To this end, the radical initiator, the base, and a solvent may be added to the BNNS, followed by heat treatment. The solvent may be a mixed solvent of water and isopropyl alcohol, but is not limited thereto.

First, oxygen-containing functional groups (—OR) derived from the radical initiator may be introduced into the BNNS through the solvothermal reaction between the BNNS and the radical initiator, whereby a plurality of B—O—R bonds can be generated on the BNNS. The R is an organic moiety derived from the radical initiator, excluding an oxygen atom from a free radical formed by the thermal decomposition of the radical initiator, and may be in the form of a monomer-derived unit or a bonded polymer chain.

The radical initiator may be a material that decomposes upon the supply of heat to form free radicals. Specifically, the radical initiator may include a peroxide. The peroxide may refer to a compound containing one or more peroxy groups. More specifically, the radical initiator may include at least one selected from: di-tert-butyl peroxide, tert-butyl peroxide (TBPO), di-tert-amyl peroxide, dicumyl peroxide, and tert-butyl cumyl peroxide. For example, the radical initiator may be di-tert-butyl peroxide.

The radical initiator may be added in an amount of 0.5 to 5 parts by weight based on 100 parts by weight of the BNNS; however, the amount is not limited thereto, and may be added in an amount greater or smaller than the aforementioned range, provided that it is a sufficient amount required for the solvothermal reaction.

The base may be added in powder form. Additionally, the base may reach a molten salt state due to the reaction temperature during the solvothermal reaction.

Specifically, the base may include at least one selected from: sodium hydroxide (NaOH), lithium hydroxide (LiOH), and potassium hydroxide (KOH). More specifically, the base may include NaOH and KOH in a weight ratio of 1:1 to 1:1.5. When a mixture of NaOH and KOH is used within this range, the melting point of the base is lowered, thereby improving process efficiency regarding the reaction temperature.

The reaction temperature for the solvothermal reaction may be 100 to 250° C. Specifically, the solvothermal reaction may be performed by sequentially establishing a first temperature range of 100 to 160° C., where thermal initiation of the radical initiator occurs, and a second temperature range of 180 to 250° C., where the base becomes a molten salt. The first range may be a temperature of 100 to 150° C., specifically 110 to 140° C., and more specifically 110 to 130° C. In addition, the second range may be a temperature of 180 to 250° C., specifically 180 to 230° C., and more specifically 180 to 220° C.

In S200, the base becomes a molten salt at the reaction temperature and may activate the edges formed in the BNNS. That is, the base may promote the reaction process between the BNNS and the radical initiator. Specifically, the base may etch the BNNS by desorbing boron or nitrogen atoms constituting the vicinity of the edge regions formed at vacancies within the BNNS and at the periphery of the BNNS, thereby activating the edge regions of the BNNS. As the edge regions are activated, the introduction of oxygen-containing functional groups derived from the radical initiator can be achieved more effectively.

Furthermore, as —OR groups are introduced into the BNNS via thermal initiation of the radical initiator and proton (H+) transfer occurs during the reaction between the hydroxyl groups (—OH) of the base and the —OR groups, hydroxylated BNNS (o-BNNS) may be formed. This increases B—O—H bonding at the edge regions of the o-BNNS.

The ratio of oxygen (O) in the o-BNNS may be approximately 30 at %, specifically 20 to 40 at %, and more specifically 25 to 35 at %.

After the solvothermal reaction in S200, a step of washing the o-BNNS with a polar solvent may be further performed. Specifically, the polar solvent may include at least one selected from isopropyl alcohol, ethyl alcohol, methanol, phenol, water, N-methyl-2-pyrrolidinone, dimethylformamide, ethyl acetate, and dimethyl sulfoxide.

Next, the o-BNNS may be dispersed in a dispersion solvent and then centrifuged to form a liquid crystalline boron nitride dope solution (S300). The boron nitride dopes solution possessing liquid crystallinity enables the spontaneous alignment of the o-BNNS by external forces during fiber spinning, which will be described later. Consequently, even when the boron nitride nanosheets are transformed into a fiber, specifically a fiber-shaped assembly or fiber material, the high in-plane thermal conductivity and mechanical strength inherent to the boron nitride nanosheets can be fully realized.

As the dispersion solvent, any solvent capable of effectively dispersing the o-BNNS to form the liquid crystalline boron nitride dope solution may be used. Specifically, a polar solvent may be used as the dispersion solvent to increase the degree of dispersion of the o-BNNS.

The centrifugation may be performed a plurality of times. Through the centrifugation, particles that are not sufficiently exfoliated and large aggregates contained in the o-BNNS powder may be removed. After performing the centrifugation, the supernatant may be recovered to obtain the liquid crystalline boron nitride dope solution. According to an embodiment, the recovered supernatant may be further centrifuged at 9,000 to 11,000 rpm for 10 to 30 minutes to concentrate the liquid crystalline boron nitride dope solution.

The o-BNNS may be included in the liquid crystalline boron nitride dope solution at a concentration of 0.1 to 10 wt %, specifically 0.2 to 4 wt %, more specifically 1 to 4 wt %, and for example 2 wt %. For details, reference may be made to the following Examples.

According to an embodiment, a step of adding a dispersant to the liquid crystalline boron nitride dope solution may be performed prior to performing a step of wet spinning the liquid crystalline boron nitride dope solution, which will be described later. The addition of the dispersant to the liquid crystalline boron nitride dope solution may further enhance the liquid crystallinity of the o-BNNS within the solution. Furthermore, the dispersant may have a high affinity for the hydroxyl groups on the surface of the o-BNNS, allowing the liquid crystalline boron nitride dope solution to form a more stable dispersed phase.

As the dispersant, at least one selected from a cellulose polymer, a cationic dispersant, an anionic dispersant, a non-ionic dispersant, and an amphoteric dispersant, which are compatible with the hydroxyl groups of the o-BNNS, may be used, but is not limited thereto. The dispersant may be a material having a hydroxyl group (—OH) or a cationic terminal group.

Specifically, the dispersant may be a cellulose polymer, and more specifically, may include at least one selected from cellulose nanocrystals (CNC) and cellulose nanofibrils (CNF).

The weight ratio of the o-BNNS to the dispersant in the liquid crystalline boron nitride dope solution may be 2:0.4 to 2:4, specifically 2:0.4 to 2:3, and more specifically 2:0.4 to 2:2. For example, the o-BNNS may be contained in a larger weight ratio than the dispersant; specifically, the weight ratio of the o-BNNS to the dispersant may be 2:0.4 to 2:1. By adding the dispersant within the aforementioned range, the dispersibility of the o-BNNS can be effectively increased without affecting its properties.

According to an embodiment, after adding the dispersant to the liquid crystalline boron nitride dope solution, a process of stirring at 400 to 600 rpm for 1 to 2 hours at room temperature may be further performed.

Next, gel fibers may be formed by wet spinning the liquid crystalline boron nitride dope solution (S400). Specifically, the liquid crystalline boron nitride dope solution may be extruded into a coagulation bath through a needle. During the process of being spun through the needle, the boron nitride nanosheets within the liquid crystalline boron nitride dope solution may be oriented by being aligned due to an external force. Specifically, during the wet spinning process, the boron nitride nanosheets included in the dope solution may be aligned along the axial direction of the fiber.

FIG. 4 is a schematic view showing a portion of a boron nitride nanosheet-based fiber manufactured according to an embodiment of the present invention.

As shown in FIG. 4, in the gel fiber formed through the wet spinning, the boron nitride nanosheets 10 may form a dense structure as they are bonded not only by van der Waals forces but also by interactions resulting from hydrogen bonding (H-bonding) between hydroxyl groups. Accordingly, the gel fiber can be easily formed without using a binder for bonding the boron nitride nanosheets 10.

Referring back to FIG. 3, an apparatus for performing the wet spinning may include a spinneret, a coagulation bath, a washing bath, and a drying unit. The gel fiber wet-spun into the coagulation bath may be solidified within the coagulation bath.

The coagulation bath may include metal cations to effectively aggregate the anionic functional groups such as hydroxyl, epoxy groups, which are oxygen-containing functional groups on the surface of the boron nitride nanosheets. Specifically, the coagulation bath may include at least one selected from monovalent or multivalent ions of cationic Ca, Na, Al, Mg, Ni, Li, Be, B, Si, and K, and complex ions such as NH₄OH, which are capable of bridging the anionic functional groups on the surface of the boron nitride nanosheets. In one embodiment, a saturated CaCl₂ solution may be used as the coagulation bath.

Furthermore, the surface tension of the coagulation bath may be configured to be lower than or similar to that of the liquid crystalline boron nitride dope solution. Specifically, the coagulation bath may further include a solvent that is the same as the solvent of the liquid crystalline boron nitride dope solution, or a solvent having a lower surface tension than the solvent of the liquid crystalline boron nitride dope solution. In detail, since the surface tension of the liquid crystalline boron nitride dope solution is lower than that of water, the coagulation bath may include, but is not limited to, a protic solvent, such as isopropyl alcohol (IPA), which has a lower surface tension than the liquid crystalline boron nitride dope solution and is capable of ionizing the metal cations (e.g., CaCl₂) of the coagulation bath.

Next, the gel fiber may be dried (S500). Specifically, the final product, a boron nitride nanosheet-based fiber, may be obtained by drying the gel fiber for 20 to 28 hours.

According to an embodiment, prior to the step of drying the gel fiber, a washing step may be performed to remove the metal ions from the coagulation bath contained in the gel fiber. A washing bath for the washing does not contain ions, and the ions in the gel fiber can be removed to the maximum extent by performing a primary washing using a solvent with lower surface tension than the liquid crystalline boron nitride dope solution similar to the coagulation bath as a primary solvent, followed by washing with water (H₂O) as a secondary solvent.

Alternatively, to completely remove the metal ions that have permeated the gel fiber from the coagulation bath, a primary washing may be performed with a pure solvent identical to that of the coagulation bath, a secondary washing in an acidic solvent of pH 6 or less, and a tertiary washing in water (H₂O) for deionizing.

In the boron nitride nanosheet-based fiber, the boron nitride nanosheets may be bonded by interactions such as van der Waals forces and hydrogen bonding. Therefore, the boron nitride nanosheet-based fiber can maintain its fibrous shape even when it does not contain a polymeric binder for bonding the boron nitride nanosheets. In addition, since the boron nitride nanosheets have a lateral size on a micrometer scale, sufficient overlap can occur between the boron nitride nanosheets along the longitudinal direction of the fiber. In the overlapping regions, the boron nitride nanosheets are bonded by the aforementioned interactions, making it easier for the fiber to maintain its shape.

As described above, the method for manufacturing a boron nitride nanosheet-based fiber of the present invention can be utilized for coatings, film fabrication, monolith structure fabrication, or polymer composite fabrication using a versatile aqueous boron nitride nanosheet solution with high dispersibility. Furthermore, coatings and other applications using this method can exhibit high electrical insulation and heat dissipation properties, and thus are expected to be applicable to dielectric materials for high-performance electronic devices, electrode coatings, and heat dissipation materials.

### Boron Nitride Nanosheet-based Fiber

Another aspect of the present invention may provide a boron nitride nanosheet-based fiber. The fiber may be manufactured by the aforementioned method for manufacturing a boron nitride nanosheet-based fiber. Accordingly, descriptions of components such as the boron nitride nanosheets constituting the boron nitride nanosheet-based fiber may refer to the details described above to avoid redundancy.

The boron nitride nanosheet-based fiber may include or may composed of boron nitride nanosheets. That is, the boron nitride nanosheet-based fiber of the present invention may include boron nitride nanosheets without the addition of a binder. Accordingly, since no binder is added, the thermal conductivity of the fiber can be improved. In one example, when the fiber is composed solely of electrically insulating materials such as boron nitride nanosheets, the fiber can be utilized as a highly insulating fiber material.

Furthermore, as shown in FIG. 4, hydrogen bonds may be formed between the boron nitride nanosheets constituting the fiber. Specifically, in the manufacturing process of the boron nitride nanosheets, the degree of formation of B—O—H bonds can be increased through the formation of vacancies whose perimeters act as edges where oxygen-containing functional groups can be introduced within the boron nitride nanosheets and the activation of edges. As the liquid crystalline dope solution containing these boron nitride nanosheets is wet-spun, hydrogen bonds can be formed between the hydroxyl groups of the boron nitride nanosheets. Thus, the fiber can have a dense structure due to the interactions by hydrogen bonding and the van der Waals forces between the boron nitride nanosheets.

The boron nitride nanosheets may be aligned in the axial direction of the fiber. Specifically, as described above, an external force may be applied to the boron nitride nanosheets as they pass through a narrow-diameter nozzle during wet spinning. This allows the boron nitride nanosheets to spontaneously align along the axial direction of the fiber. Consequently, the fiber can exhibit high axial thermal conductivity and improved mechanical strength.

Additionally, the boron nitride nanosheet-based fiber of the present invention can be utilized as a functional fiber material requiring high thermal conductivity, high toughness, and electrical insulation; a polymer composite; and in applications such as semiconductor substrates, packaging materials, battery packaging, low-dielectric materials, and high-heat-dissipation materials. Specifically, the boron nitride nanosheet-based fiber of the present invention can be utilized in the form of filamentary fibers. It can also be incorporated as continuous or short fibers into polymer composites, high-thermal-conductivity polymer composites, or high-toughness polymer composites. Such materials can be applied to sheaths, brake disks, and various other products that utilize conventional high-toughness composites. Furthermore, it can be used as an insulating material with high thermal conductivity for electronic substrates, batteries, and other related applications.

Hereinafter, preferred experimental examples are presented to facilitate understanding of the present invention. However, the following experimental examples are merely for providing a better understanding of the present invention, and the present invention is not limited by the following experimental examples.

### Boron Nitride Nanosheet (BNNS) Preparation Example 1

High-purity hexagonal boron nitride (h-BN) powder of 99% was used. Oxidized hexagonal boron nitride (o-h-BN) was prepared by heat-treating the h-BN powder at 800° C. for 2 hours under air conditions including humidity. The o-h-BN was dispersed at a concentration of 3 mg/ml in a solvent mixture of isopropanol (IPA) and deionized water (DIW) in a volume ratio of 6:4, thereby obtaining an o-h-BN dispersion. Thereafter, the o-h-BN dispersion was subjected to bath sonication for 1 hour to exfoliate the bulk-type o-h-BN into boron nitride nanosheets (BNNS), thereby obtaining a BNNS dispersion in which the exfoliated BNNS were dispersed in the solvent. During the exfoliation process, a chiller was used to prevent overheating and maintain a stable temperature. After completing the sonication, the BNNS dispersion was washed to remove the solvent, and BNNS in powder form were obtained.

### BNNS Preparation Example 2

BNNS were obtained in the same manner as in BNNS Preparation Example 1, except that the heat treatment of the h-BN powder was performed at 1,000° C.

### BNNS Preparation Example 3

BNNS were obtained in the same manner as in BNNS Preparation Example 1, except that the heat treatment of the h-BN powder was performed at 1,200° C.

### BNNS Comparative Example 1

BNNS were obtained in the same manner as in BNNS Preparation Example 1, except that the heat treatment of the h-BN powder was not performed.

The heat treatment temperatures of the h-BN powder performed in BNNS Preparation Examples 1 to 3 and Comparative Example 1 are summarized in Table 1 below.

TABLE 1

| | heat treatment temperature |
|---|---|
| | of h-BN powder |
| BNNS Preparation Example 1 | 800° C. |
| BNNS Preparation Example 2 | 1000° C. |
| BNNS Preparation Example 3 | 1200° C. |
| BNNS Comparative Example 1 | No heat treatment |

### Boron Nitride Fiber (BNF) Preparation Example 1

(1) Formation of Hydroxylated Boron Nitride Nanosheets (o-BNNS)

To the BNNS powder obtained in BNNS Preparation Example 1, 4 ml of di-tert-butylperoxide as a radical initiator, and 110 mg of sodium hydroxide (NaOH) powder and 130 mg of potassium hydroxide (KOH) powder as bases were added. A first reaction was performed at 120° C. for 12 hours, followed by a second reaction at 180° C. for 12 hours to complete a solvothermal reaction. For the solvothermal reaction, a solvent consisting of IPA and DIW at a volume ratio (v/v) of 6:4 was used. Upon completion of the solvothermal reaction, hydroxylated boron nitride nanosheets (o-BNNS) were formed. Subsequently, the product was washed with a polar solvent composed of IPA and DIW at a volume ratio of 6:4 (v/v) to obtain o-BNNS powder.

(2) Formation of a o-BNNS Dispersion

The obtained o-BNNS powder was redispersed in a solvent composed of IPA and DIW at a volume ratio of 6:4 (v/v) to form the o-BNNS dispersion.

### (3) Formation of a Liquid Crystalline Boron Nitride Dope Solution

The o-BNNS dispersion was centrifuged at 1,000 rpm for 20 minutes to remove insufficiently exfoliated particles and large aggregates. After recovering the supernatant, additional centrifugation was performed at 10,000 rpm for 1 hour to concentrate the o-BNNS, thereby preparing a liquid crystalline boron nitride dope solution containing o-BNNS at a concentration of 2 wt %.

### (4) Fiber Formation Via Wet-Spinning

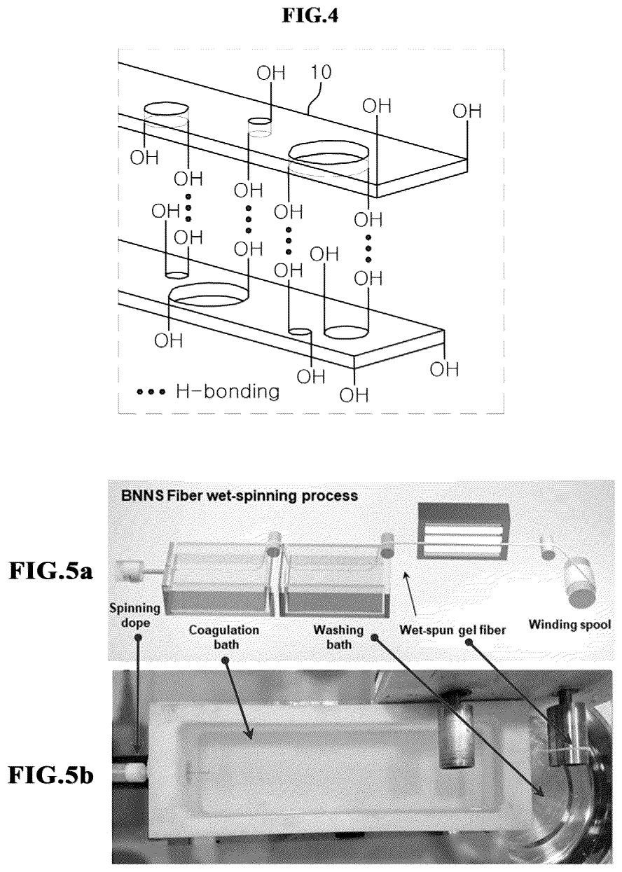

FIG. 5a is a schematic diagram illustrating wet-spinning process of the liquid crystalline boron nitride dope solution according to BNF Preparation Example 1, and FIG. 5b is an actual image of the wet-spinning process.

Referring to FIGS. 5a and 5b, a boron nitride fiber (BNF) was fabricated by a wet-spinning process using the liquid crystalline boron nitride dope solution. Specifically, as a coagulation bath for spinning, a cationic coagulation bath composed of an IPA solution in which CaCl₂) was dissolved to a saturated concentration was prepared. The liquid crystalline boron nitride dope solution was injected into a 22-gauge spinneret needle and spun into the coagulation bath at an average spinning speed of 1.21 m/day using a syringe pump, forming a gel fiber as it solidified in the coagulation bath.

### (5) Washing and Drying of the Gel Fiber

Referring to FIGS. 5a and 5b, after collecting the formed gel fiber, residual CaCl₂ and solvent were removed by washing with IPA in a washing bath. The washed wet-spun gel fiber was dried for 24 hours to prepare a final boron nitride nanosheet-based fiber, hereinafter referred to as “boron nitride fiber (BNF)”. The prepared fiber was collected using a winding spool.

### BNF Preparation Example 2

BNF was prepared in the same manner as in BNF Preparation Example 1, except that the BNNS powders obtained in BNNS Preparation Example 2 were used.

### BNF Preparation Example 3

BNF was prepared in the same manner as in BNF Preparation Example 1, except that the BNNS powders obtained in BNNS Preparation Example 3 were used.

### BNF Preparation Example 4

BNF was prepared in the same manner as in BNF Preparation Example 2, except that a liquid crystalline boron nitride dope solution containing 0.5 wt % of o-BNNS was used.

### BNF Preparation Example 5

BNF was prepared in the same manner as in BNF Preparation Example 2, except that a liquid crystalline boron nitride dope solution containing 1 wt % of o-BNNS was used.

### BNF Preparation Example 6

BNF was prepared in the same manner as in BNF Preparation Example 2, except that a liquid crystalline boron nitride dope solution containing 4 wt % of o-BNNS was used.

### BNF Preparation Example 7

BNF was prepared in the same manner as in BNF Preparation Example 2, except that wet-spinning was performed after a process of further adding a dispersant into the liquid crystalline boron nitride dope solution.

The specific process of further adding the dispersant is as follows. Cellulose nanocrystals (CNCs) having hydroxy groups were added to the liquid crystalline boron nitride dope solution. Upon addition, the weight ratio of o-BNNS to CNC in the liquid crystalline boron nitride dope solution was 2:0.4. The liquid crystalline boron nitride dope solution to which the CNCs were added was stirred at 500 rpm for 1 hour at room temperature to ensure that the CNCs were uniformly dispersed. Subsequently, a solvent mixture of IPA and DIW in a 6:4 volume ratio was added to adjust the viscosity and ensure the stability of the liquid crystalline boron nitride dope solution.

### BNF Preparation Example 8

BNF was prepared in the same manner as in BNF Preparation Example 7, except that the weight ratio of o-BNNS to CNC in the liquid crystalline boron nitride dope solution was adjusted to 2:2.

### BNF Preparation Example 9

BNF was prepared in the same manner as in BNF Preparation Example 7, except that the weight ratio of o-BNNS to CNC in the liquid crystalline boron nitride dope solution was adjusted to 2:4.

### BNF Comparative Example 1

BNF was prepared in the same manner as in BNF Preparation Example 1, except that the BNNS powders obtained in BNNS Comparative Example 1 were used.

### BNF Comparative Example 2

BNF was prepared in the same manner as in BNF Preparation Example 7, except that the BNNS powders obtained in BNNS Comparative Example 1 were used and the weight ratio of o-BNNS to CNC in the liquid crystalline boron nitride dope solution was adjusted to 2:2.

### BNF Comparative Example 3

BNF was prepared in the same manner as in BNF Preparation Example 7, except that the BNNS powders obtained in BNNS Comparative Example 1 were used and the weight ratio of o-BNNS to CNC in the liquid crystalline boron nitride dope solution was adjusted to 2:4.

BNF Preparation Examples 1 to 9 and Comparative Examples 1 to 3 are summarized in Table 2 below.

TABLE 2

| | | Concentration | | | |
|---|---|---|---|---|---|
| | | of o-BNNS | | | Weight ratio of |
| | | (wt %) | | | o-BNNS:Dispersant |
| BNF Preparation or | BNNS Preparation or | (in Dope | | Dispersant | (w:w) (in Dope |
| Comparative Example | Comparative Example | Solution) | | (CNC) | Solution) |
| Preparation Example 1 | Preparation Example 1 | 2 | wt % | None | — |
| Preparation Example 2 | Preparation Example 2 | 2 | wt % | None | — |
| Preparation Example 3 | Preparation Example 3 | 2 | wt % | None | — |
| Preparation Example 4 | Preparation Example 2 | 0.5 | wt % | None | — |
| Preparation Example 5 | Preparation Example 2 | 1 | wt % | None | — |
| Preparation Example 6 | Preparation Example 2 | 4 | wt % | None | — |
| Preparation Example 7 | Preparation Example 2 | 2 | wt % | Added | 2:0.4 |
| Preparation Example 8 | Preparation Example 2 | 2 | wt % | Added | 2:2 |
| Preparation Example 9 | Preparation Example 2 | 2 | wt % | Added | 2:4 |
| Comparative Example 1 | Comparative Example 1 | 2 | wt % | None | — |
| Comparative Example 2 | Comparative Example 1 | 2 | wt % | Added | 2:2 |
| Comparative Example 3 | Comparative Example 1 | 2 | wt % | Added | 2:4 |

The fiber obtained in BNF Preparation Example 7 exhibited a thermal conductivity of 28.19 Wm⁻¹K⁻¹, as measured by the T-shape method without any additional reduction treatment. Furthermore, as a result of measurement using a universal testing machine (UTM), it exhibited a mechanical strength of approximately 110 MPa.

In contrast, for the fiber obtained in BNF Comparative Example 1, which was prepared using the BNNS exfoliated without heat treatment obtained in BNNS Comparative Example 1, the thermal conductivity was 29.2 Wm⁻¹K⁻¹ and the mechanical strength was 20 MPa.

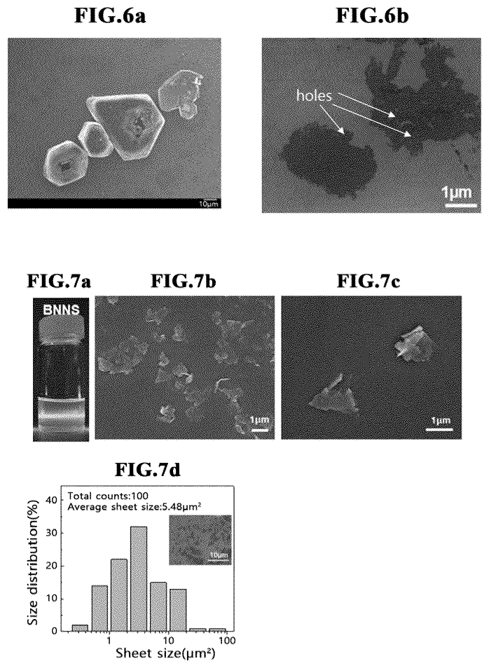

FIG. 6a is a scanning electron microscope (SEM) image of h-BN crystals after the heat treatment process in BNNS Preparation Example 2, and FIG. 6b is an SEM image of the BNNS formed by exfoliation after the heat treatment in BNNS Preparation Example 2.

Referring to FIG. 6a, it can be confirmed that vacancies or holes were formed inside the h-BN crystals by the heat treatment process in a water vapor atmosphere.

Referring to FIG. 6b, it can be confirmed that vacancies or holes were formed within a basal plane of the BNNS of BNNS Preparation Example 2 formed by exfoliating the h-BN crystals. The perimeters of these vacancies can be defined as internal edge regions possessing dangling bonds. The average hole size within these BNNS was approximately 0.00545 μm².

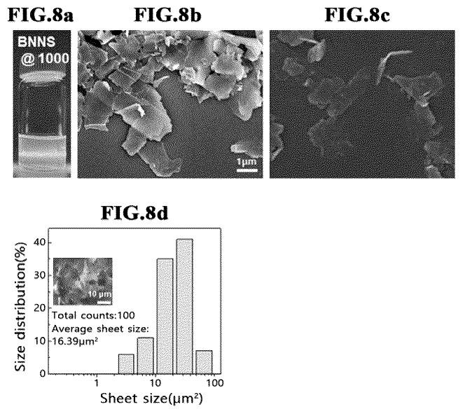

FIGS. 7b and 7c are SEM images of the BNNS obtained in BNNS Comparative Example 1, FIG. 7a is a photograph of a BNNS dispersion containing the BNNS obtained from BNNS Comparative Example 1 exhibiting the Tyndall effect to evaluate the degree of dispersion, and FIG. 7d is a graph of the particle size distribution showing the degree of dispersion of the BNNS obtained from BNNS Comparative Example 1. FIGS. 8b and 8c are SEM images of the BNNS obtained in BNNS Preparation Example 2, FIG. 8a is a photograph of a BNNS dispersion containing the BNNS obtained from BNNS Preparation Example 1 exhibiting the Tyndall effect to evaluate the degree of dispersion, and FIG. 8d is a graph of the particle size distribution showing the degree of dispersion of the BNNS obtained from BNNS Preparation Example 1.

Comparing the SEM images in FIGS. 7b and 7c and the SEM images in FIGS. 8b and 8c, it can be confirmed that in the case of BNNS Comparative Example 1, where heat treatment was not performed prior to exfoliation, the exfoliated BNNS are agglomerated and form clusters of small sizes. Referring to FIG. 7d, the average size of the BNNS obtained in BNNS Comparative Example 1 was found to be 5.48 μm².

In contrast, in the case of BNNS Preparation Example 2, it can be confirmed that the BNNS were exfoliated to an appropriate size and thickness for fiber formation. Referring to FIG. 8d, the average size of the BNNS obtained in BNNS Preparation Example 2 was found to be 16.39 μm².

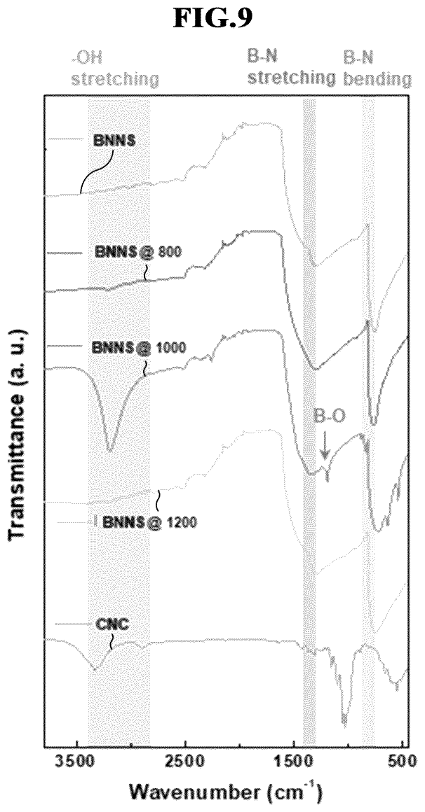

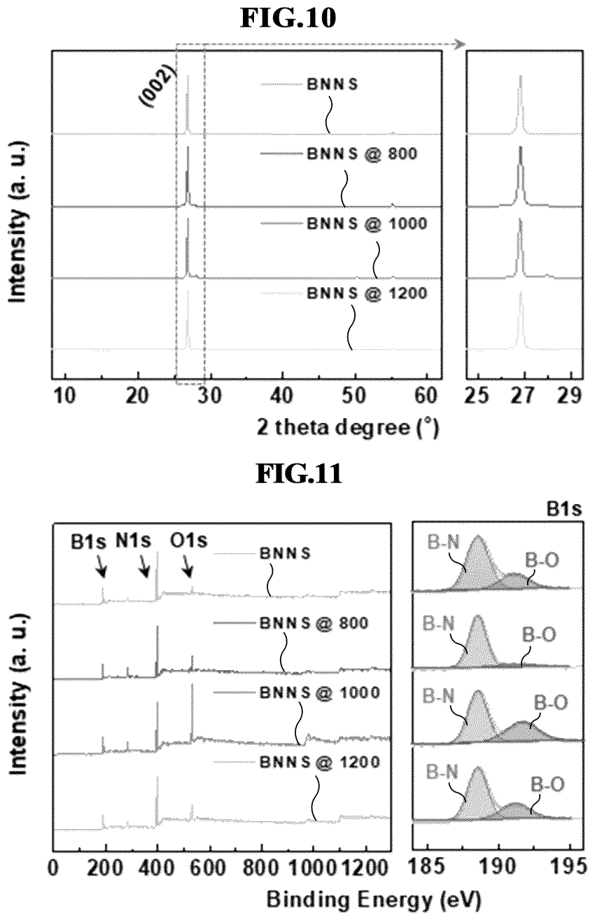

FIGS. 9 to 11 show analysis results of the o-BNNS powders obtained through the solvothermal reaction in BNF Preparation Examples 1 to 3 and Comparative Example 1. Specifically, FIG. 9 shows results analyzed by Fourier transform infrared (FTIR) spectroscopy, FIG. 10 shows results analyzed by X-ray diffraction (XRD), and FIG. 11 shows results analyzed by X-ray photoelectron spectroscopy (XPS). In FIGS. 9 to 11, BNNS@800, BNNS@1000, BNNS@1200, and BNNS represent the o-BNNS obtained during the process of BNF Preparation Examples 1, 2, and 3, and Comparative Example 1, respectively.

Referring to FIG. 9, unlike other samples, it can be confirmed that a B—O bonding peak appears in the o-BNNS powder that underwent the solvothermal reaction in BNF Preparation Example 2 (indicated as BNNS@1000).

Referring to FIG. 10, it can be confirmed that all o-BNNS have a layered structure stacked in the (002) direction.

Referring to FIG. 11, the o-BNNS that underwent the solvothermal reaction in BNF Preparation Example 2 (indicated as BNNS@1000) exhibited the highest intensity of the Ols peak, confirming an increase in B—O bonding.

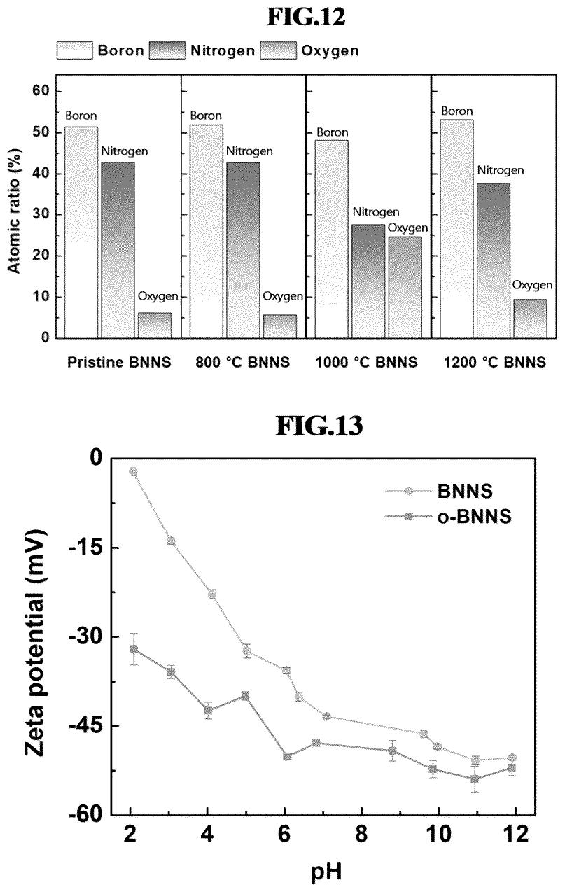

FIG. 12 is a graph comparing the atomic ratios calculated using XPS for the o-BNNS powders obtained through the solvothermal reaction in BNF Preparation Examples 1 to 3 and Comparative Example 1. In FIG. 12, 800° C. BNNS, 1000° C. BNNS, 1200° C. BNNS, and pristine BNNS represent the o-BNNS obtained during the process of BNF Preparation Examples 1, 2, and 3, and Comparative Example 1, respectively.

Referring to FIG. 12, unlike the o-BNNS powders of BNF Comparative Example 1 (indicated as pristine BNNS) and Preparation Example 1 (indicated as 800° C. BNNS), it can be confirmed that the oxygen (O) atomic ratio increased in the o-BNNS powders of BNF Preparation Examples 2 and 3 (indicated as 1000° C. BNNS and 1200° C. BNNS). In particular, the oxygen atomic ratio in o-BNNS powders of BNF Preparation Example 2 (indicated as 1000° C. BNNS) was the highest. This can be attributed to the heat treatment temperature prior to exfoliation.

As described above, it is evident that a higher density of oxygen-containing functional groups can be introduced onto the surface of o-BNNS by performing a solvothermal reaction on BNNS that has been exfoliated following the heat treatment of h-BN. Furthermore, it can be confirmed that the introduction of oxygen-containing functional groups during the solvothermal reaction is most effective when the pre-exfoliation heat treatment is conducted at temperatures exceeding 800° C., particularly at 1,000° C.

FIG. 13 is a graph comparing the zeta potential, which represents the surface potential, of o-BNNS obtained after the solvothermal reaction in BNF Preparation Example 2 and Comparative Example 1. In FIG. 13, o-BNNS and BNNS represent the o-BNNS obtained in BNF Preparation Example 2 and Comparative Example 1, respectively.

As shown in FIG. 13, the zeta potential of the o-BNNS from BNF Preparation Example 2 (indicated as o-BNNS) was compared with that of the o-BNNS from BNF Comparative Example 1 (indicated as BNNS). The pH was adjusted using NaOH for basic conditions and HCl for acidic conditions via a pH titrator. The zeta potential was calculated by back-calculating the drift velocity of ions measured through electrophoresis.

It can be confirmed that the zeta potential of the o-BNNS from BNF Preparation Example 2 (indicated as o-BNNS) remained below −30 mV across the entire experimental pH range. It is generally known that a stable colloidal dispersion can be formed when the zeta potential of colloidal particles in a solution is −30 mV or less. This indicates that the surface charge intensity of the o-BNNS from BNF Preparation Example 2 is significantly higher than that of that of the o-BNNS from BNF Comparative Example 1. This can be attributed to the successful introduction of numerous oxygen-containing functional groups onto the o-BNNS in BNF Preparation Example 2.

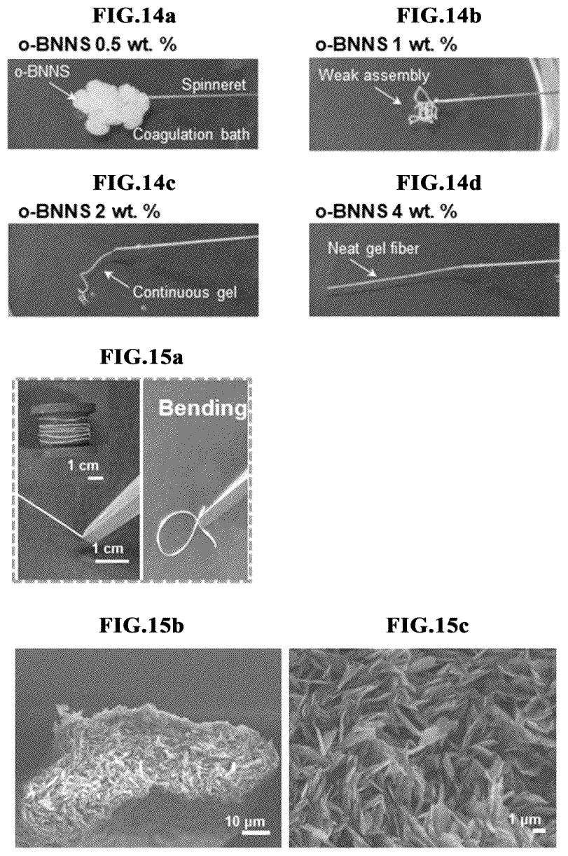

FIGS. 14a, 14b, 14c, and 14d are images showing the gel fibers formed in a coagulation bath through wet-spinning using a spinneret in BNF Preparation Examples 4, 5, 2 and 6, respectively.

Referring to FIGS. 14a, 14b, 14c, and 14d, it can be observed that the morphology of the gel fibers formed through the wet-spinning process varies depending on the concentration of o-BNNS containing oxygen-containing functional groups within the liquid crystalline boron nitride dope solution in BNF Preparation Examples 4, 5, 2 and 6.

In FIG. 14a, when the concentration of o-BNNS in the liquid crystalline boron nitride dope solution of BNF Preparation Example 4 is 0.5 wt %, it can be confirmed that the fiber fails to maintain its shape and undergoes disintegration.

In FIG. 14b, when the concentration of o-BNNS in the liquid crystalline boron nitride dope solution of BNF Preparation Example 5 is 1 wt %, long fiber shapes are observed, but they are formed as weak assemblies, leading to partial breakage.

In FIG. 14c, when the concentration of o-BNNS in the liquid crystalline boron nitride dope solution of BNF Preparation Example 2 is 2 wt %, it is confirmed that the fibers are formed in the shape of a continuous gel.

In FIG. 14d, even when the concentration of o-BNNS in the liquid crystalline boron nitride dope solution of BNF Preparation Example 6 is 4 wt %, the formation of neat gel fibers can be clearly observed.

FIG. 15a shows photographic images and FIGS. 15b and 15c are cross-sectional SEM images of the boron nitride nanosheet-based fiber obtained in BNF Preparation Example 2.

Referring to FIG. 15a, it can be confirmed that the fiber prepared in BNV Preparation Example 2 is well-formed into a thin and elongated shape, and it can be bent flexibly without breaking even when bending is performed.

Referring to FIGS. 15b and 15c, it can be observed that a plurality of BNNS are aligned along the axial direction of the fiber and are very densely packed.

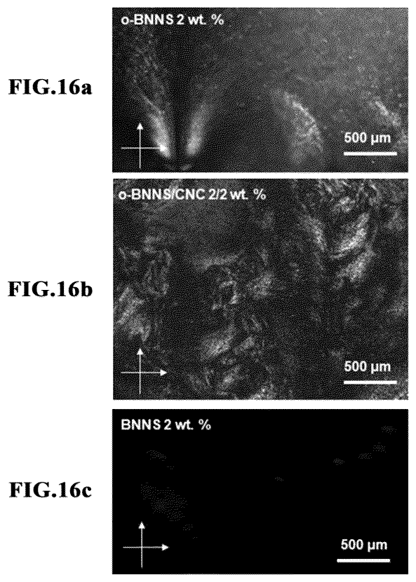

FIGS. 16a, 16b, and 16c are polarized optical microscopy (POM) images observing the liquid crystalline phase with a 200 m gap for the liquid crystalline boron nitride dope solution containing 2 wt % o-BNNS prepared in BNF Preparation Example 2, the liquid crystalline boron nitride dope solution containing 2 wt % o-BNNS and 2 wt % CNC prepared in BNF Preparation Example 8, and the liquid crystalline boron nitride dope solution containing 2 wt o-BNNS prepared in BNF Comparative Example 1, respectively.

Referring to FIGS. 16a, 16b, and 16c, it can be confirmed that the dope solution from BNF Preparation Example 2 and the dope solution further containing CNC from BNF Preparation Example 8 exhibit a bi-phase nematic liquid crystalline phase in polar solvents such as water (H₂O). Since CNC also possesses a negative surface charge and exhibits a nematic liquid crystalline phase at about 2 wt % concentration, the o-BNNS:CNC mixture at a 2:2 weight ratio in BNF Preparation Example 8 showed a strong liquid crystalline phase extended throughout the entire region compared to the pure o-BNNS in BNF Preparation Example 2 at the same concentration. Conversely, as in BNF Comparative Example 1, when heat treatment was not performed prior to exfoliation, a stable liquid crystalline phase was not observed at any concentration fraction.

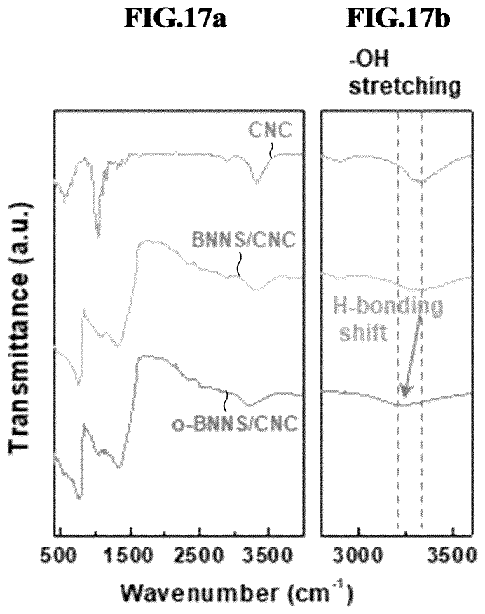

FIGS. 17a and 17b are Fourier-transform infrared (FTIR) spectra of the BNFs from BNF Preparation Example 7 and Comparative Example 2, and the CNC dispersant as a control.

Referring to FIGS. 17a and 17b, in the case of the BNF from BNF Comparative Example 2 (indicated as BNNS/CNC), it can be confirmed that the peak position of the hydroxyl group is the same as that of the CNC dispersant. In contrast, in the case of the BNF from BNF Preparation Example 7 (indicated as o-BNNS/CNC), a shift in the hydroxyl group peak is observed. This can be attributed to the formation of inter-nanosheet hydrogen bonding (H-bonding) within the fiber, which is believed to result from the interaction of hydroxyl groups on the o-BNNS surface.

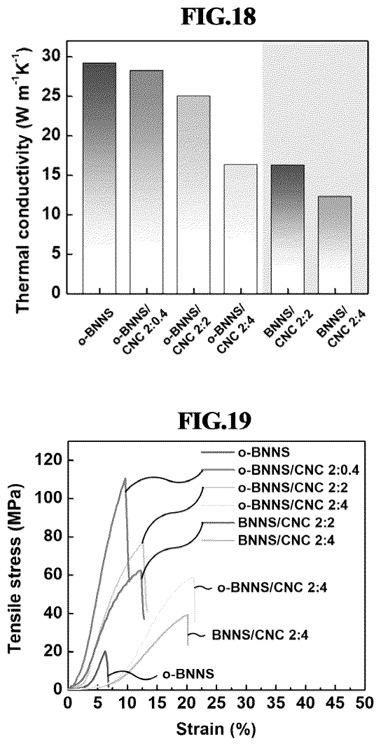

FIG. 18 is a graph comparing the thermal conductivity of the fibers prepared from BNF Preparation Examples 2, 7 to 9 and Comparative Examples 2 and 3.

Referring to FIG. 18, it can be confirmed that the BNF obtained in BNF Preparation Example 2 (indicated as o-BNNS), which does not contain CNC in the liquid crystalline boron nitride dope solution, exhibits the highest thermal conductivity. When CNC is included in the dope solution, the BNF from BNF Preparation Example 7 (indicated as o-BNNS/CNC 2:0.4), with an o-BNNS:CNC weight ratio of 2:0.4, shows the highest thermal conductivity. Furthermore, as seen in BNF Preparation Examples 8 and 9 (indicated as o-BNNS/CNC 2:2 and o-BNNS/CNC 2:4), as the weight ratio of the CNC dispersant increases, the thermal conductivity of the resulting BNF decreases compared to that obtained in BNF Preparation Example 7.

The fibers prepared from BNF Comparative Examples 2 and 3 respectively indicated as BNNS/CNC 2:2 and BNNS/CNC 2:4, including BNNS that did not undergo heat treatment prior to exfoliation, exhibited significantly lower thermal conductivity compared to the fibers prepared from BNF Preparation Examples 7 and 8 indicated as o-BNNS/CNC 2:0.4 and o-BNNS/CNC 2:2. Meanwhile, the liquid crystalline dope solution containing BNNS that did not undergo heat treatment prior to exfoliation and CNC at 2:0.4 weight ratio could not form fibers as the wet-spinning was not feasible.

FIG. 19 is a graph comparing the tensile stress of the fibers prepared in BNF Preparation Examples 2, 7 to 9 and Comparative Examples 2 and 3.

Referring to FIG. 19, it can be confirmed that the fiber prepared in BNF Preparation Example 7 indicated as o-BNNS/CNC 2:0.4 exhibits the highest tensile strength at a strain of less than 10%. Compared to the fiber prepared in BNF Preparation Example 7, the fibers prepared in BNF Preparation Examples 8 and 9 which have a higher addition ratio of CNC respectively indicated as o-BNNS/CNC 2:2 and o-BNNS/CNC 2:4 exhibit lower tensile strength but maintain a certain level of tensile stress even at strains of 10% or more, and 20% or more.

As described above, the boron nitride nanosheet-based fibers of the present invention can effectively improve mechanical strength and thermal conductivity.

The method for manufacturing boron nitride nanosheets according to the present invention may generate vacancies within a plurality of boron nitride nanosheets constituting hexagonal boron nitride (h-BN) by heat-treating the h-BN in a water vapor atmosphere prior to exfoliation. The boron nitride nanosheets (BNNS) formed by exfoliating the h-BN may possess vacancies within its basal plane, where nitrogen and boron are connected via sp² hybridized bonds. The boundaries of these vacancies may act as internal edges with exposed dangling bonds formed by the disconnection of chemical bonds between nitrogen and boron, through which oxygen-containing functional groups, specifically hydroxyl groups (—OH), can be introduced.

Furthermore, the manufacturing method of the boron nitride nanosheet-based fiber according to the present invention involves a solvothermal reaction of the BNNS under basic conditions. This process can further break the bonds between boron and nitrogen atoms at the peripheral and internal edge regions of the BNNS to create additional dangling bonds, and/or activate existing dangling bonds. These activated edge regions can increase the introduction of hydroxyl groups (—OH), ultimately enhancing the formation of B—O—H bonds within the BNNS.

The boron nitride nanosheet-based fibers manufactured in the present invention can possess a dense structure and exhibit high mechanical strength and improved thermal conductivity. This is due to the generation of interactions through hydrogen bonding between hydroxyl groups, in addition to the Van der Waals forces between the BNNS.

In addition, since the boron nitride nanosheet-based fibers manufactured in the present invention are composed solely of insulating materials such as BNNS, they can be utilized as a high-insulation fiber material.

Although the present invention has been described in detail with reference to the exemplary embodiments, the present invention is not limited to the above described exemplary embodiments, and various modifications and alternations can be devised by those skilled in the art without departing from the technical spirit and scope of the present invention.

What is claimed is:

1. A method for manufacturing a boron nitride nanosheet-based fiber, comprising:
preparing boron nitride nanosheets (BNNS);
forming hydroxyl-functionalized boron nitride nanosheets (o-BNNS) by adding a radical initiator and a base to the BNNS and performing a solvothermal reaction;
dispersing the o-BNNS in a dispersion solvent and centrifuging the same to form a liquid crystalline boron nitride dope solution;
forming gel fibers by wet-spinning the liquid crystalline boron nitride dope solution; and
drying the gel fibers.

2. The method of claim 1, wherein the BNNS have vacancies formed therein.

3. The method of claim 1, wherein the radical initiator comprises a peroxide.

4. The method of claim 1, wherein the base comprises at least one selected from the group consisting of sodium hydroxide (NaOH), lithium hydroxide (LiOH), and potassium hydroxide (KOH).

5. The method of claim 4, wherein the base comprises the NaOH and the KOH in a weight ratio of 1:1 to 1:1.5.

6. The method of claim 1, wherein the solvothermal reaction is performed at a first reaction temperature of 120 to 160° C., at which the radical initiator is thermally initiated; and at a second reaction temperature of 180 to 250° C., at which the base becomes a molten salt.

7. The method of claim 1, wherein an atomic ratio of oxygen contained in o-BNNS is 5 to 25%.

8. The method of claim 1, further comprising, prior to forming the liquid crystalline boron nitride dope solution, washing the o-BNNS with a polar solvent.

9. The method of claim 1, wherein a concentration of the o-BNNS in the liquid crystalline boron nitride dope solution is 1 to 4 wt %.

10. The method of claim 1, further comprising, prior to wet-spinning the liquid crystalline boron nitride dope solution, adding a dispersant to the liquid crystalline boron nitride dope solution.

11. The method of claim 10, wherein a weight ratio of the o-BNNS to the dispersant in the liquid crystalline boron nitride dope solution is 2:0.4 to 2:4.

12. A method for manufacturing boron nitride nanosheets, comprising:
heat-treating hexagonal boron nitride (h-BN) powder in a water vapor atmosphere; and
forming boron nitride nanosheets (BNNS) by dispersing the heat-treated h-BN powder in a solvent and then performing ultrasonic treatment.

13. The method of claim 12, wherein the heat-treating is performed at a temperature higher than 800° C. and not higher than 1,200° C.

14. The method of claim 12, wherein an average size of the BNNS is 10 to 40 μm².

15. A fiber comprising boron nitride nanosheets, wherein hydrogen bonds are formed between the boron nitride nanosheets.

16. The fiber of claim 15, wherein vacancies are formed inside the boron nitride nanosheets.

17. The fiber of claim 15, wherein the boron nitride nanosheets are aligned in an axial direction of the fiber.
